(19) United States
(12) Patent Application Publication
(10) Pub. No.: US 2018/0022040 A1
(43) Pub. Date: Jan. 25, 2018

(54) Bonding Polytetrafluoroethylene Sheeting to Cementitious, Stone, Tile, Fiberglass and Metal Surfaces

(71) Applicant: Mascorp, Ltd., Houston, TX (US)

(72) Inventors: George More, Houston, TX (US); James Jackson Henry, Houston, TX (US)

(73) Assignee: Mascorp, Ltd., Houston, TX (US)

(21) Appl. No.: 15/633,350

(22) Filed: Jun. 26, 2017

Related U.S. Application Data
(60) Provisional application No. 62/355,206, filed on Jun. 27, 2016.

(51) Int. Cl. B29C 65/00; C09J 7/02; B29C 65/48

(52) U.S. Cl. CPC B29C 66/7392; B29C 65/48; B29C 66/47; C09J 7/0267; B29K 2627/18

(57) ABSTRACT

The disclosure provides a method for the bonding of polytetrafluoroethylene sheets of various thicknesses to various surfaces. A method may include removing contaminants from a substrate for the application of the polytetrafluoroethylene sheet; applying adhesive to an etched side of the polytetrafluoroethylene sheet; and installing the polytetrafluoroethylene sheet to the substrate.

This application is a non-provisional of U.S. application Ser. No. 62/355,206 filed on Jun. 27, 2016, which is incorporated by reference in its entirety.

### BACKGROUND

Polytetrafluoroethylene (“PTFE”) is a synthetic fluoropolymer of tetrafluoroethylene. PTFE may be a high molecular weight fluorocarbon solid compound that includes carbon and fluorine. PTFE may be hydrophobic (i.e., neither water nor water-containing substances wet PTFE as fluorocarbons may demonstrate mitigated dispersion forces due to the high electronegativity of fluorine). PTFE may have one of the lowest coefficients of friction of any solid.

PTFE may be used as a non-stick coating for pans and other cookware. It is non-reactive, partly due to the strength of the carbon-fluorine bonds, and so it may often be utilized in containers and pipework for reactive and corrosive chemicals. Where used as a lubricant, PTFE may reduce friction, wear and energy consumption of machinery.

PTFE may be well known for its heat resistance, chemical resistance, corrosion resistance and anti-stick properties. Because of these properties, PTFE may include a wide range of applications including applications to various surfaces. However, because of its anti-stick properties, special techniques may be utilized to provide adherence of PTFE to surfaces.

### BRIEF DESCRIPTION OF THE DRAWINGS

These drawings illustrate certain aspects of some examples of the present disclosure and should not be used to limit or define the disclosure.

FIG. 1 illustrates a substrate with PTFE sheets attached thereto.

### DETAILED DESCRIPTION

The present disclosure may relate to the bonding of PTFE sheets of various thicknesses to various surfaces using surface preparation, adhesive formulations and field applicable techniques, which may include, for example, peel and stick techniques, as well as, liquid adhesive techniques.

In embodiments, PTFE is a polymer of tetrafluoroethylene. In embodiments, PTFE may have a density of about 2,200 kg/m³. PTFE may have a melting point of about 600 K (327° C.; 620° F.). PTFE may maintain strength, toughness and self-lubrication at temperatures of about 5 K (−268.15° C.; −450.67° F.), and flexibility at temperatures above about 194 K (−79° C.; −110° F.). PTFE may gain its properties from the aggregate effect of carbon-fluorine bonds. Additionally, PTFE may have a thermal expansion of about 112-125×10⁻⁶ K⁻¹; a thermal diffusivity of about 0.124 mm²/s; Young's modulus of about 0.5 GPa; a yield strength of about 23 MPa; a bulk resistivity of about 1016 Ω·m; a coefficient of friction of about 0.05-0.10; a dielectric constant of =2.1, tan(δ)<5(−4); and a dielectric strength at 1 MHz of about 60 MV/m. It is to be understood that the aforementioned properties are examples of PTFE properties, but PTFE properties may have broader and narrower ranges with any such properties.

Embodiments of the present disclosure may be utilized in any industrial facility. For instance, industrial facilities include chemical plants, refineries and the like. The chemical bond of the PTFE sheets and adhesive may create a wide range of resistance capabilities for various industries that deal with caustic and hazardous chemicals. Without limitation, examples of hazardous chemicals may include potassium perchlorate (KCIO₄), ammonium nitrate (NH₄NO₃), 2,4,6-Trinitrotoluene (TNT), hydrogen peroxide (H₂O₂) (i.e., industrial concentrations of 35% and above), nitromethane (CH₃NO₂), hydrocarbons, or combinations thereof. Processes disclosed herein may provide for long term protection of containment areas against many different kinds of leaking chemicals, and may also allow for an easier cleanup in chemical processes where cleanups may be difficult.

The PTFE sheets, as described herein, may allow for walking, driving, and other types of vehicular or pedestrian activity to occur thereon, which has typically not been possible. In certain embodiments of the present disclosure, 100% PTFE sheets may be bonded to surfaces and/or substrates, such as, for example, metal, concrete, stone, wood, fiber glass, cementitious materials or combinations thereof.

Surface/substrate preparation (e.g., blast cleaning) may be a first stage treatment of a substrate before an application of a PTFE sheet to the substrate. Blast cleaning may include propelling a stream of abrasive material against a surface under high pressure to smooth a rough surface, roughen a smooth surface, shape a surface, and/or remove surface contaminants. A pressurized fluid, such as, without limitation, compressed air may be used to propel the blasting material. There may be numerous variants of the blast cleaning process. A highly abrasive variant may include shot blasting (i.e., metal shot) and sandblasting (i.e., sand). Moderately abrasive variants may include glass bead blasting and blasting with ground-up material, such as, for example, plastics and/or walnut shells. A mild version may be soda blasting (i.e., baking soda). In addition, there may be alternatives that are less abrasive or nonabrasive, such as, for example, ice blasting and/or dry-ice blasting. The performance of the PTFE sheet may be influenced by its ability to adhere properly to the substrate material. Correct surface preparation may be a factor affecting surface treatment. Without limitation, the presence of even small amounts of surface contaminants, such as, for example, moisture, oil, grease, and/or oxides may physically impair and reduce PTFE sheet adhesion to the substrate. Residues of oil, grease, marking inks, and/or cutting oils after manufacturing operations may affect the adhesion of applied PTFE sheets and may be removed. Without limitation, failure to remove these contaminants before a blast cleaning may result in them being distributed over the substrate surface and contaminating any adhesive. Organic solvents, emulsion degreasing agents or equivalents may be applied as surface treatment to remove contaminants in preparation for subsequent surface proppant such as descaling treatments. In certain embodiments, a primer may be applied to the substrate after it has been surface treated. Primer is applied to a portion or substantially all of the surface. Surface proppant includes removing such contaminants before blast cleaning. In embodiments, the primer may be a moisture mitigating primer. Examples of suitable moisture mitigating primer are barrier type primers that may comprise, but are not limited to, alkyds such as glyptal; epoxies such as an inorganic zinc-rich epoxy; urethanes such as phenylurethane; acrylics such as a poly(methyl methaacrylate)-water emulsion; zinc silicate, or any combinations thereof. The primers have a thickness of about 1 mil to about 14 mils, or alternatively about 3 mils to about 12 mils. The primer may be applied by any suitable method. Suitable methods include by brush, spray, or combinations thereof.

The type and size of the abrasive used in blast cleaning may have an effect on the profile produced on the surface. In addition to the degree of cleanliness (i.e., removal of contaminants), surface preparation specifications may consider surface texture relative to the PTFE sheet to be applied. Inadequate quality control and lack of restriction of large abrasive particle sizes for PTFE sheets may lead to peaks of the blast cleaned surface not being adequately covered. Examples of abrasives may include, but are not limited to, metal shot, sand, plastics, walnut shells, baking soda or any combination thereof.

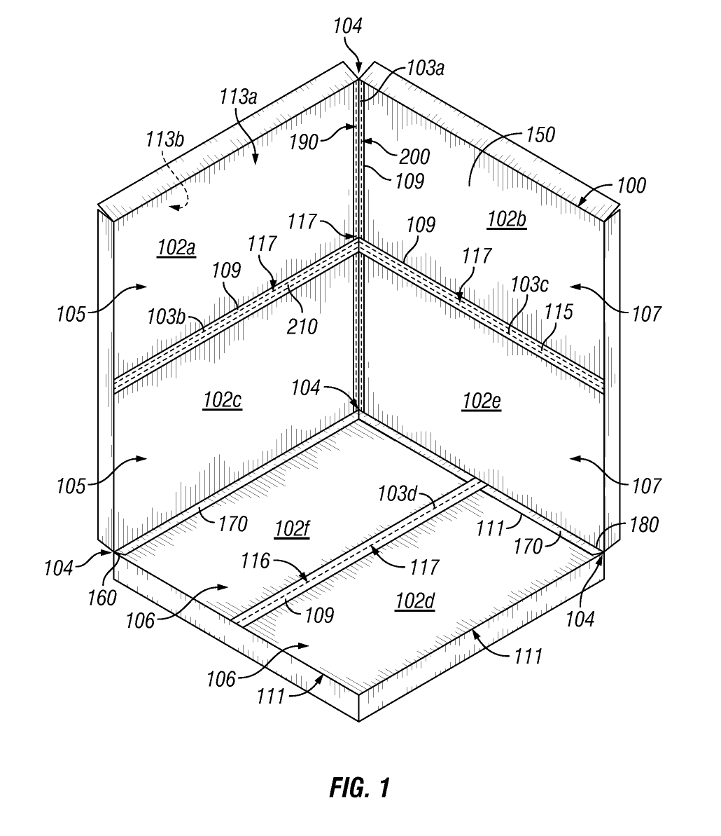

FIG. 1 illustrates substrate 100 with PTFE sheets 102(a)-(f). Substrate 100 may be made of metal, concrete, stone, wood, fiber glass, cementitious materials, or combinations thereof. Substrate 100 may include concrete for containment of a chemical spill, a container wall, a drainage channel wall and the like. The concrete may have a strength ranging from about 1,000 psi to about 3,000 psi, from about 3,000 psi to about 6,000 psi, from about 6,000 psi to about 10,000 psi, or greater than 10,000 psi. In certain embodiments, substrate 100 may be three dimensional and include any suitable shape, such as, for example, a polyhedron (e.g., a tetrahedron, a cube, a octahedron, a dodecahedron, a icosahedron), a cylinder, a prism, a pyramid, a sphere, a cone, a torus, or combinations thereof. After surface treatment of substrate 100, as discussed above, the surface area 150 of substrate 100 may be measured to allow proper coverage of substrate 100 with the PTFE sheets 102(a)-(f). Each of the PTFE sheets 102(a)-(f) may include a first side (e.g., side 113a of PTFE sheet 102a) and a second side (e.g., side 113b of PTFE sheet 102a). Each of the PTFE sheets 102(a)-(f) may be etched on one side or on both sides (e.g., sides 113a and 113b of PTFE sheet 102(a)) by a chemical and/or mechanical etching process. The etching on one side or on both sides may facilitate attachment/bonding of the PTFE sheets 102(a)-(f) to the substrate 100. Etching may refer to preparing a surface of a PTFE sheet 102 by removing (e.g., cutting) a portion of the surface. Etching may comprise of applying an etch onto the surface. Any suitable form of etching may be used. In an embodiment, etching comprises chemical etching. Chemical etching may comprise any chemical etching suitable for PTFE such as tetraethylene glycol dimethyl ether, diethylene glycol dimethyl ether, ethylene glycol dimethyl ether, sodium ammonia, sodium naphthalene, or any combinations thereof.

In certain embodiments, each of PTFE sheets 102(a)-(f) may include a substantially flat surface, which may be of any suitable shape, such as, for example, a parallelogram, a triangle, a circle, an ellipse, or combinations thereof. Each of PTFE sheets 102(a)-(f) may include any suitable width, such as, a width from about 1 inch to about 1,000 inches, alternatively about 25 inches to about 500 inches, about 48 inches to about 100 inches, or about 36 inches to about 60 inches. Without limitation, the length of each of PTFE sheets 102(a)-(f) may be of any suitable length, such as, for example, about 6 inches to about 48 inches, about 48 inches to about 100 inches, about 100 inches to about 200 inches, or greater than about 200 inches. The thickness of each of PTFE sheets 102(a)-(f) may range from about 10 mm to about 120 mm. In certain embodiments, each of PTFE sheets 102(a)-(f) may be divided (e.g., cut) into smaller sections, such as, for example, sections (e.g., smaller strips) with a width ranging from about 3 inches to about 6 inches, or about 6 inches to about 18 inches. Each PTFE sheet may have a thickness ranging from about 1 mm to about 100 mm.

In operation, the type of chemicals, temperature, and exposure to environmental issues for the PTFE sheets 102(a)-(f) may be determined by any suitable means, such as, a consultation with plant site engineers. Each of PTFE sheets 102(a)-(f) may have adhesive applied to the etched side(s) before they are positioned and attached (i.e., installed) to the substrate 100 (i.e., the surface area 150 of substrate 100), as illustrated. In some embodiments, PTFE sheets 102(a), 102(b), 102(c), and 102(e) (i.e., the wall PTFE sheets) may be installed before PTFE sheets 102(d) and 102(f) (i.e., the floor PTFE sheets). For instance, the PTFE sheets installed on the sides 105, 107 (i.e. walls) may be installed before any PTFE sheets are installed on the floor 106 of substrate 100. In certain embodiments, a reason for installing PTFE sheets 102(a), 102(b), 102(c), and 102(e) (i.e., the wall PTFE sheets) before installing PTFE sheets 102(d) and 102(f) (i.e., the floor PTFE sheets) may be to ensure that any overlapping PTFE sheets 102(a)-(f) may create a substantially seamless interface between vertical and horizontal PTFE sheets 102(a)-(f). In some embodiments, the floor PTFE sheets may be positioned so that they may be disposed up to the corners (e.g., corners 104) and along the edges 111 of the substrate 100, so that multiple layers of PTFE sheets 102(a)-(e) may overlap at the corners (e.g., corners 104) and along the sides (e.g., sides 105, 107) of substrate 100. Pressure may be utilized to install PTFE sheets 102(a)-(f). The pressure may be applied by any suitable method. In embodiments, the pressure is applied by roller, press or any combinations thereof. PTFE sheet 102(c) may be folded at end 160 providing folded portion 170. Folded portion 170 is secured to floor 106 in such an embodiment. PTFE sheet 102(e) may be folded at end 180 providing folded portion 180. Folded portion 180 is secured to floor 106 in such an embodiment. In embodiments as shown, folded portions 170, 180 extend from edge 111 onto floor 106. In some embodiments, end portion 190 of PTFE sheet 102(a) and end portion 200 of PTFE sheet 102(e) overlap at corner 104. In embodiments, end portion 190 is disposed upon end portion 200. In other embodiments, end portion 200 is disposed upon end portion 190. In other embodiments, end portions 190, 200 substantially abut upon each other.

After PTFE sheets 102(a)-(f) are installed (i.e. attached), seams 103(a)-(d) may expose substrate 100 between PTFE sheets 102 (a)-(f), as illustrated. Seam 103(a) comprises where the opposing edges of PTFE sheet 102(a) and 102(b) are proximate to each other and where the opposing edges of PTFE sheet 102(c) and 102(e) are proximate to each other. Seam 103(b) comprises where the opposing edges of PTFE sheet 102(a) and 102(c) are proximate to each other. Seam 103(c) comprises where the opposing edges of PTFE sheet 102(b) and 102(e) are proximate to each other. Seam 103(d) comprises where the opposing edges of PTFE sheet 102(d) and 102(f) are proximate to each other. Seam 103(b) may be positioned at the midpoint 210 of side 105, thereby extending about perpendicularly of side 107, as illustrated. Seam 103(c) may be positioned at about a midpoint 115 of side 107, thereby extending about perpendicularly of side 105, as illustrated. Seam 103(d) may be positioned at a midpoint 116 of floor 106, thereby extending perpendicularly of floor 100, as illustrated. Each of the PTFE sheets 102 (a)-(f), as discussed above, may extend to be in contact with an opposing PTFE sheet 102(a)-(f). In embodiments, PTFE strip 109 may be positioned over or under (i.e., overlaid or under laid) the seams 103(a)-(d). PTFE strips 109 may be disposed about in the middle 117 of each of seams 103(a)-103(d). Without limitation, this may ensure that chemicals are prevented from leaking where PTFE sheets 102(d) and 102(f) (i.e., the floor PTFE sheets) or PTFE sheets 102(a), 102(b), 102(c), and 102(e) (i.e., wall PTFE sheets) meet, and may create a double strength layer instead of a weaker seal area. Additionally, a PTFE strip 109 may be installed at each corner 104 of substrate 100, thereby extending vertically along seam 103(a), as illustrated. PTFE strip 109 may have any suitable width, such as, a width ranging from about 3 inches to about 6 inches, or about 6 inches to about 18 inches. Without limitation, the length of PTFE strip 109 may be of any suitable length, such as, for example, about 6 inches to about 48 inches, about 48 inches to about 100 inches, about 100 inches to about 200 inches, or greater than about 200 inches.

Any suitable adhesives may be used. In embodiments, adhesives for use with temperatures above about 250° F. may include aliphatic amine, 1,2,3,6-tetrahydromethyl-3,6-methano-phthalicanhydride, polymer of epichlorohydrin, phenol-formaldehyde novolac, ceramic-filled epoxies, any other adhesives noted for the about −350° F. to about 250° F. adhesives, or combinations thereof. Commercial examples of suitable adhesives include Aremco™ 2335-B and 2335-A, which are ceramic filled epoxies from Aremco. Adhesives for use with temperatures ranging from about −350° F. to about 250° F. may include 3,3′-oxybis(ethyleneoxy)bis(propylamine), aminophenol (or aminophenol substitutes), polyglycol diamine, acid salt, glycerol, diethyleneglycol monoethyl ether, alcohol derivatives such as furfuryl alcohol, ethylene glycol, any other adhesives noted for the above about 250° F. adhesives, or combinations thereof. Without limitation, the adhesive may be applied to the side or sides of the PTFE sheet that contacts the substrate or another PTFE sheet. Without limitation, the adhesive may be applied to the PTFE sheet by any suitable means, such as, spray, brush, roller, peel and stick, or combinations thereof. Peel and stick refers to a removable surface under which there is an adhesive.

Although the present disclosure and its advantages have been described in detail, it should be understood that various changes, substitutions and alterations may be made herein without departing from the spirit and scope of the disclosure as defined by the appended claims.

What is claimed is:

1. A system comprising:
a polytetrafluoroethylene sheet; and
an adhesive, wherein the adhesive comprises an aliphatic amine; a 1,2,3,6-tetrahydromethyl-3,6-methano-phthalicanhydride; a polymer of epichlorohydrin; a phenol-formaldehyde novolac; a ceramic-filled epoxy; a 3,3′-oxybis(ethyleneoxy)bis(propylamine); an aminophenol (or aminophenol substitutes); a polyglycol diamine; an acid salt; a glycerol; a diethyleneglycol monoethyl ether; an alcohol derivative; ethylene glycol; or combinations thereof.

2. The system of claim 1, wherein the polytetrafluoroethylene sheet comprises a first side and a second side.

3. The system of claim 2, wherein the first side is etched.

4. The system of claim 2, wherein the second side is etched.

5. The system of claim 2, wherein the first and second sides are etched.

6. The system of claim 1, wherein a thickness of the polytetrafluoroethylene sheet is from about 10 mm to about 120 mm.

7. The system of claim 1, wherein a length of the polytetrafluoroethylene sheet is from about 48 inches to about 100 inches.

8. The system of claim 1, wherein a width of the polytetrafluoroethylene sheet is from about 36 inches to about 60 inches.

9. The system of claim 1, wherein the adhesive is configured to adhere to a substrate at a temperature above about 250° F.

10. The system of claim 1, wherein the adhesive is configured to adhere to a substrate at a temperature from about −350° F. to about 250° F.

11. A method for a bonding of a polytetrafluoroethylene sheet to a substrate, the method comprising:
removing contaminants from a substrate for application of the polytetrafluoroethylene sheet;
applying adhesive to an etched side of the polytetrafluoroethylene sheet; and
applying the polytetrafluoroethylene sheet to the substrate.

12. The method of claim 11, wherein the substrate comprises metal, concrete, stone, wood, cementitious materials, fiber glass, or combinations thereof.

13. The method of claim 11, further comprising dividing the polytetrafluoroethylene sheet into sections.

14. The method of claim 11, wherein the substrate is three dimensional.

15. The method of claim 14, wherein the substrate comprises a shape comprising a polyhedron, a cylinder, a prism, a pyramid, a sphere, a cone, a torus, or combinations thereof.

16. The method of claim 11, wherein the polytetrafluoroethylene sheet comprises a substantially flat surface.

17. The method of claim 16, wherein the substantially flat surface comprises a shape of a parallelogram, a triangle, a circle, an ellipse, or combinations thereof.

18. The method of claim 11, further comprising removing caustic and hazardous chemicals.

19. The method of claim 11, wherein the removing contaminants comprises blast cleaning with shot.

20. The method of claim 11, wherein the applying adhesive comprises spraying the adhesive, brushing the adhesive, rolling the adhesive, or combinations thereof.
